(19) United States
(12) Patent Application Publication
(10) Pub. No.: US 2010/0270039 A1
(43) Pub. Date: Oct. 28, 2010

(54) Fire fighting unit for a vehicle

(76) Inventors: Darren John Hennessy, Boulder (AU); Christopher Mark White, Boulder (AU)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 12/658,866

(22) Filed: Feb. 16, 2010

(30) Foreign Application Priority Data
Apr. 22, 2009 (AU) AU2008101240 A4

(51) Int. Cl. A62C 27/00

(52) U.S. Cl. 169/24

(57) ABSTRACT

A fire fighting unit for a vehicle that can be carried attached to the vehicle in a steel cover with a hose attached. During normal transit a tank containing fire retardant is uncharged. When required a manual release is operated charging the tank with compressed air. When fully charged the outlet can be opened providing pressurised fire retardant on demand. The unit can be refilled via an outlet. Preferably a hose is attached to the outlet valve.

### CROSS-REFERENCE TO RELATED APPLICATION

This application claims priority from Australian Patent Application 2008101240 filed Apr. 22, 20098 entitled Inline Vehicle Self Contained Fire Fighting Unit, the entire specification of which is incorporated by reference herein.

### FIELD OF THE INVENTION

The present invention relates to a fire fighting unit for a vehicle. The invention is particularly suited to heavy vehicles, such as trucks.

Many vehicles, especially trucks, experience tyre fires when transporting goods. These fires can result in total destruction of a vehicle and the death of the driver. In the case of hazardous and dangerous goods, a tyre fire can cause damage to life and property extending beyond the vehicle and driver.

The load and type of the vehicle quite often results, despite the best efforts of the driver, with the onboard fire fighting equipment being inaccessible and time consuming to implement. It is also quite often inappropriate for the size and intensity of tyre fires. Tyre fires in particular require immediate high density saturation.

Many fire fighting solutions currently available for use on vehicles are not able to be reused.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

According to the present invention there is provided a fire fighting unit for a vehicle including a tank with a first inlet for receiving a fire retardant, a second inlet and an outlet, wherein the second inlet is arranged for connection to a compressed air supply belonging to the vehicle so that compressed air can be delivered to the tank when triggered by a user, the compressed air serving to charge the tank so that fire retardant under pressure can be discharged via the outlet by the user.

Once charged the fire fighting unit is ready to discharge the fire retardant onto a fire, preferably via a hose or the like that is attached to the outlet.

The fire fighting unit preferably includes a manual release for triggering delivery of the compressed air into the tank. The manual release is preferably a valve operable by the user, typically the driver.

The tank can be refilled with fire retardant after use, without removing it from the vehicle. This enables the tank to be carried continuously on the vehicle.

### DESCRIPTION OF THE DRAWINGS

To assist with understanding the invention reference will now be made to the accompanying drawings which now show one example of the invention.

The drawings show one example of the invention. In the drawings:

FIG. 1 shows a top view of the cylinder that contains fluid and valves.

FIG. 2 shows a side view of the cylinder that contains fluid and valves.

FIG. 3 shows a top elevation view of the exterior cover.

FIG. 4 shows a front elevation view of the exterior cover.

FIG. 5 shows an end elevation view of the cylinder.

FIG. 6 shows a view of exterior cover inclusive of a retardant delivery hose.

### DETAILED DESCRIPTION OF THE PREFERRED EMBODIMENT

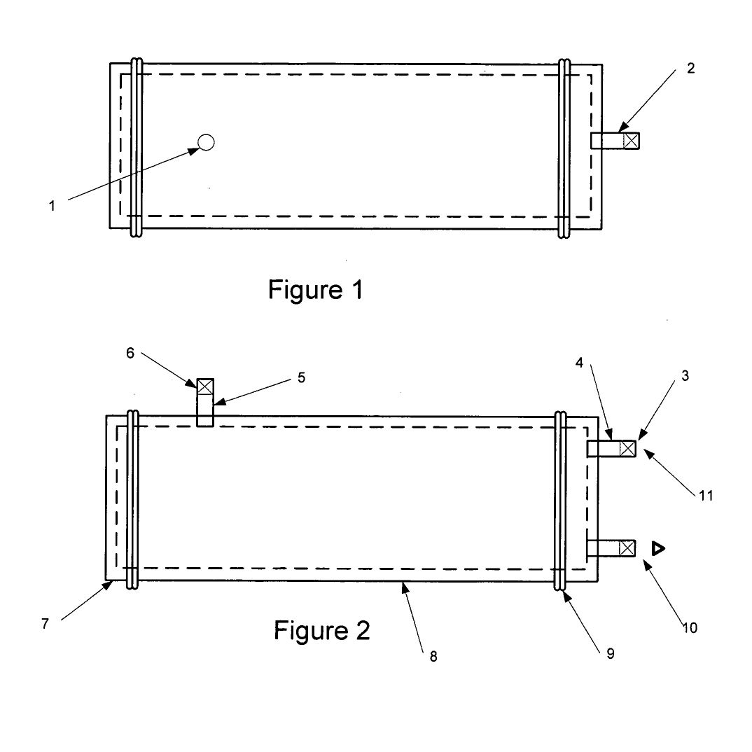

Referring to FIG. 1, it can be seen one refill point 1 and portals for input of compressed air and discharge of liquid 2.

Referring to FIG. 2, it can be seen that the refill inlet (FIG. 1, 1) is comprised of a cover 6 and 20 an outlet protrusion 5, the inlet for compressed air 4 with a non return valve 3 that is attached to the existing air supply 11 of the vehicle.

The tank or cylinder 7, 8 is comprised of high density polyethylene (HDPE) and any joins will be via mechanical welds 9. The discharge outlet is shown 10.

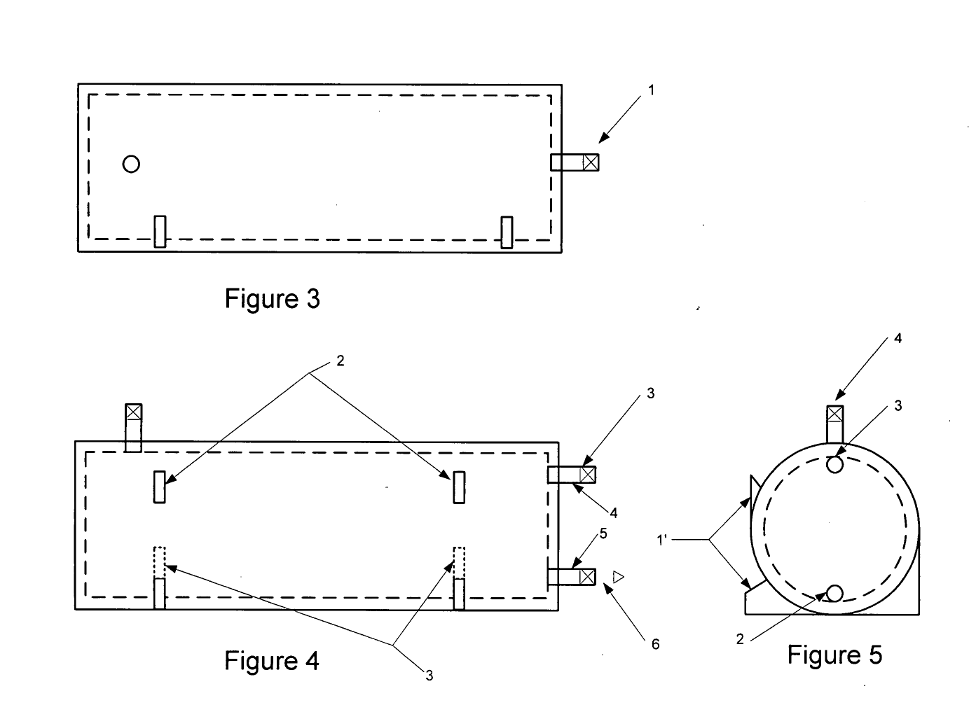

FIG. 3 is comprised of a top elevation view of the exterior cover. The discharge 1 and inlet 1 points are shown. The inlet for refill 2 is also shown.

FIG. 4 is comprised of a front elevation view of the exterior cover, the refill inlet is shown 1, the brackets for the hose 2 and mounting brackets 3. The non return valve for compressed air 4 and the valve for fluid discharge 5 are displayed, the outlet hose 6 attached to the valve 5.

FIG. 5 comprises of an end elevation view of the cylinder, and the supporting brackets 1 for the exterior cover, the outlet for fluid 2, the compressed air intake 3 and the refill point 4.

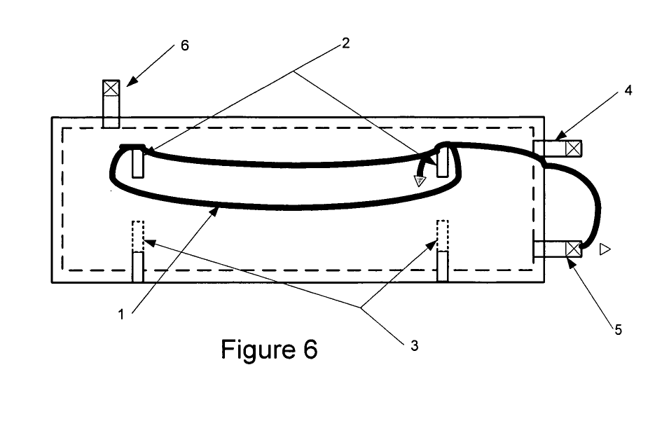

FIG. 6 comprises of the exterior cover inclusive of retardant delivery hose 1. Hose brackets 2 and mounting brackets 3, the compressed air inlet 4 and hose connection 5 is shown. The refill point 6 is also shown.

The fire fighting unit of the present embodiment is designed to be attached via appropriate brackets to the vehicle in reasonable proximity to the vehicle's tyres. The cylinder (tank) that is filled with fire retardant is carried on the vehicle uncharged. If there is a fire then a manual release of a valve charges the cylinder with compressed air from the compressed air supply. That supply is an existing air supply on the vehicle.

The fire fighting unit once charged enables fire retardant to be delivered under pressure to the fire.

The embodiment has been described by way of example only and modifications within the spirit and scope of the invention are envisaged.

What is claimed is:

1. A fire fighting unit for a vehicle including a tank with a first inlet for receiving a fire retardant, a second inlet and an outlet, wherein the second inlet is arranged for connection to a compressed air supply belonging to the vehicle so that compressed air can be delivered to the tank when triggered by a user, the compressed air serving to charge the tank so that fire retardant under pressure can be discharged via the outlet by the user.

2. A fire fighting unit according to claim 1 including a manual release for triggering delivery of the compressed air into said tank.

3. A fire fighting unit according to claim 2 wherein the manual release is a valve operable by the user.

4. A fire fighting unit according to claim 1 further including means for mounting the unit to the vehicle.

5. A fire fighting unit according to claim 1 further including a length of hose connected to the outlet and wherein the tank and hose are arranged for storage within a cover.
